(19) United States
(12) Patent Application Publication
(10) Pub. No.: US 2022/0097248 A1
(43) Pub. Date: Mar. 31, 2022

(54) Segmented Die Comprising Master Die and Interchangeable Die Rule Inserts

(71) Applicant: Atlas Die, LLC, Rochester Hills, MI (US)

(72) Inventors: William A. Schmutzer, Monroe, GA (US); Matthew J. VanDyke, Elkhart, IN (US); Lloyd Hilligoss, South Lyon, MI (US); Travis A. Moellers, Crawfordsville, IN (US); Jerry Wallis Melson, JR., Conyers, GA (US)

(73) Assignee: Atlas Die, LLC, Rochester Hills, MI (US)

(21) Appl. No.: 17/037,036

(22) Filed: Sep. 29, 2020

(51) Int. Cl. B26F 1/44

(52) U.S. Cl. CPC B26F 1/44; B26F 2001/4436; B26F 2001/4463

(57) ABSTRACT

A composite die retaining board and composite die are provided. The composite die retaining board includes a master die retaining board having a die rule insert-receiving recess, and a die rule insert installed in the die rule insert-receiving recess. The die rule insert has a shape that is complementary to the shape of the die rule insert-receiving recess. A plurality of interlock features extending from an outer periphery of the die rule insert and interlock with interlock bays formed and intersecting with the die rule insert-receiving recess. Methods of exchanging a die rule insert with a different die rule insert are also provided and enable a rapid swapping-out of different die rule inserts.

### FIELD OF THE INVENTION

The present invention relates to die rule retaining boards, and methods of quickly changing die rule lay-outs and cutting designs.

### BACKGROUND OF THE INVENTION

Die rule retaining boards have long been known. Such boards typically have a pattern of die slots each configured to accommodate and retain a respective die rule or die rule portion. The die rules can be cutting rules, creasing rules, perforating rules, or the like. Die slots can be formed, for example, by laser cutting. Die rules are placed in the die slots and are designed to fit snugly within the slots. Although friction alone can be used to retain the die rules in the die slots, biasing devices are often used for this purpose. Biasing devices can be included along the die slots, for example, held in die lock slots arranged perpendicularly to and intersecting with an elongated die slot. Such biasing devices can include spring-type devices that urge a die rule against an opposing wall of the die slot, or magnetic devices that attract and hold a metal die rule against an adjacent wall of the die slot. Such biasing devices are known and can be in the form of die locks such as the KERF LOCK or the NEVERDIE DIE, both available from Atlas Die, LLC of Rochester Hills, Michigan.

Designing a die rule layout, forming the die slots and die lock slots, and installing the die rules and die locks can be complicated and time-consuming. Moreover, making even small changes to the die cutting pattern can involve starting all over with a new die rule retaining board, a new set of die rules, and a new set of die locks. A need exists for a system and method to more easily make changes to a die rule layout, design, or pattern.

### SUMMARY OF THE INVENTION

The foregoing and other objects are provided by the segmented die of the present invention. The segmented die comprises a master die that includes a recess for an insert, and one or more interchangeable die rule inserts that fit into the recess. The combination of the master die and insert provides a segmented die retaining board into which die rules can be inserted to form a completed die. Changes to the design of the completed die can be made quickly and easily according to the methods of the present invention.

According to various embodiments of the present invention, a master die includes a retaining board that engages and holds one of a plurality of different interchangeable die rule inserts. The system enables methods of quickly swapping-out one die rule insert for another, thus prolonging and maximizing the use of a master die. According to various embodiments of the present invention, the master die retaining board is provided with a die rule insert-receiving recess into which interchangeable die rule inserts can be installed. A system of dove-tails provides very accurate positioning and a firm holding of the different die rule inserts in the die rule insert-receiving recess. Each die rule inserts can be provided with threaded through-holes for enabling ejection bolts or screws to engage the insert, pass through the insert, and press against an underlying recess bottom. In cases where the die rule insert-receiving recess of the master die comprises a complete through passage, such that there is no bottom of the recess, the distal ends of the ejection bolts then press against the surface of a die cutting chase or platen onto which the master die has been mounted. By turning the ejection bolts, the insert can be pried away from the recess to the point where it can be removed and then replaced or re-tooled.

The footprint of the recess can be formed completely within the cutting footprint of the master die. Alternatively, the footprint of each insert can be adjacent to or overlap the cutting footprint of the master die. The interchangeability and cooperation of the interchangeable inserts with respect to the master die and its recess enables time-savings when swapping-out die rule inserts. Rapid changes to an overall die pattern are thus enabled.

According to various embodiments, the master die need not be removed from a chase or platen while the die rule insert is swapped-out. The same master die can thus be used over and over, with less-expensive, smaller, and more focused die rule inserts that can be replaced over time.

As an example, a master die pattern can provide a footprint for forming a six-sided box, and different die rule inserts can be provided for changing the die cutting pattern within one or more panels of the six-sided box. As such, containers of the same overall size and shape can be made but having different panel punch-outs, cut-outs, creases, or perforations.

As a further example, a master die pattern can provide a footprint for forming a six-sided box, and one die rule insert can be inserted into the master die to provide a die-cutting pattern that results in a house-shaped, perforated punch-out on a first side of the box. In a quick-change operation, the die rule insert can be swapped-out with a different die rule insert that instead provides a die-cutting pattern that forms a character-shaped or animal-shaped, perforated punch-out on the first side. According to the present invention, the swap-out can occur without the need to change the master die and without the need to change die rules that are exclusively inserted in the master die. The master die, including the retaining board of the master die, can remain, for example, positioned on, mounted to, and/or bolted onto a die-cutting chase or platen, for example, in a die cutting press. Great time-savings results as the master die can remain relatively undisturbed during the swapping-out operation.

Moreover, a die rule insert can be used that can form die-cut patterns on or in more than one panel of a box or other container. Die-cutting patterns along two, three, four, or more sides of a container formed from a master die and insert can simultaneously be changed by changing only the die rule insert. In an example, die-cut patterns on four vertical side panels of a six-sided box can quickly be changed to four different die-cut patterns by swapping-out a single die rule insert. Perforated die-cut patterns for forming punch-outs corresponding to four major characters of a movie can be provided on four respective vertical side panels. By swapping-out a single die rule insert and leaving the master die relatively undisturbed, the perforated die-cut patterns can quickly be changed. Perforated die-cut patterns can quickly be changed to provide die-cutting patterns that correspond to four different side-panel designs, for example, four different major characters from the same movie or from a different movie.

The overall die pattern, comprising the master die pattern and the die rule insert pattern, can quickly be updated according to the systems and methods of the present invention. Updates can be made to reflect different characters, for example, characters form a recently released movie or show. The master die can thus be used over and over while the die rule inserts can be changed to provide, for example, different perforated punch-out figures, different perforated punch-out characters, different shapes, different current events, different historical figures, different entertainers, different current entertainment features, or to otherwise provide different designs, over time, on one or more panels of a container.

Each die rule insert can have the same outer peripheral shape. The outer peripheral shape can be complementary to an inner peripheral shape of a corresponding master die insert-receiving recess. The master die insert-receiving recess can have a depth that extends all the way through the master die retaining board, for example, such that the back or mounting surface of the master die and the back or mounting surface of the die rule insert can be flush with one another. Both the back or mounting surface of the master die and the back or mounting surface of the die rule insert can rest on the same mounting surface of the same chase or platen. The master die can be bolted or otherwise fixed to the chase or platen whereas the die rule insert can either be bolted to the chase or platen or held in the master die insert-receiving recess by: friction alone, friction fit coupled with adhesive; adhesive alone; or the like.

In some embodiments, the outer shape and periphery of the die rule insert can have the same shape and dimensions as the inner shape and periphery of the master die insert-receiving recess. In other words, the shape and size of the die rule insert can be complementary to the shape and size of the master die insert-receiving recess. As such, the die rule insert might need to be slightly sanded or smoothed so that it can fit within the master die insert-receiving recess. In some cases, the die rule insert, the master die insert-receiving recess, or both, can be machined, for example, sanded, laser-cut, or otherwise formed, to be from just one one-thousandth to ten one-thousandths of an inch different. For example, the die rule insert can be machined to be five one-thousandths of an inch smaller in length and width compared with the length and width of the master die insert-receiving recess. A tight fit can be desirable. To remove such a tightly fitted die rule insert from the master die insert-receiving recess, ejection bolts as described herein, can be used.

According to various embodiments of the present invention, a die rule insert can be removed from a master die insert-receiving recess by threading an ejection bolt through the die rule insert such that a distal end thereof presses against the mounting surface of the chase or platen holding the master die to thus lift or force the die rule insert away from the chase or platen and away from the master die. In cases where the master die insert-receiving recess includes a bottom, the distal ends of the ejection bolts can press against the bottom of the master die insert-receiving recess to thus lift or force the die rule insert away from the master die. For this purpose, a single ejection bolt or multiple ejection bolts can be provided, and the die rule insert can be provided with one or more ejection bolt threaded through-holes for receiving one or more ejection bolts.

Methods of changing a die rule pattern are also provided and can involve maintaining a master die fixed to a chase while removing a die rule insert from the master die. The method can involve: die-cutting a workpiece, for example, a paperboard, with a master die and first die rule insert combination; exchanging the first die rule insert for a second die rule insert; and then die-cutting with the master die and second die rule insert combination. The entire process of ejecting the first die rule insert and inserting the second die rule insert can be accomplished in mere minutes, for example, in ten minutes or less, in fifteen minutes or less, in twenty minutes or less, or in thirty minutes or less. As such, great time savings are provided as is prolonged use of the master die.

The foregoing and other objects are achieved according to the present invention as described and claimed below and as embodied in the attached drawings.

### BRIEF DESCRIPTION OF THE DRAWINGS

The invention may be more fully understood with reference to the accompanying drawings. The drawings are intended to illustrate, not limit, the present teachings.

FIG. 1A is a top plan view of a master die including an insert-receiving recess and die rule slots, according to an embodiment of the present invention.

FIG. 1B is an enlarged view of section 1B shown in FIG. 1A.

FIG. 2A is a top plan view of a die rule insert including die rule slots, according to an embodiment of the present invention.

FIG. 2B is an enlarged view of section 2B shown in FIG. 2A.

FIG. 3 is an enlarged view of an exemplary four-corner-rounded dovetail interlock feature according to various embodiments of the present invention.

FIG. 4 is an enlarged view of an exemplary six-corner-rounded, stemmed dovetail interlock feature according to various embodiments of the present invention.

FIG. 5 is a top plan view of a composite die including the master die shown in FIGS. 1A and 1B and the die rule insert shown in FIGS. 2A and 2B, wherein the die rule insert has been inserted into the master die insert-receiving recess and die rules have been inserted in all of the die rule slots.

FIG. 6 is a top plan view of a completed composite die including the composite die shown in FIG. 5 and elastically deformable ejection material fixed around the die rules.

FIG. 7 is a close-up side view of a corner of a completed composite die that also comprises a counterplate aligned therewith in a manner such that the corner roll pin shown extends from a hex bushing in the composite die to and through a counterplate alignment through-hole.

FIG. 8 is a top view of a counterplate that can be aligned with the completed composite die shown in FIG. 6 and shows alignment through-hole features that can be aligned with corresponding roll pin alignment features added to the completed composite die.

### DETAILED DESCRIPTION OF THE INVENTION

According to various embodiments of the present invention, a composite die retaining board is provided as is a composite die made from the composite die retaining board. The composite die retaining board comprises a master die retaining board and a die rule insert. The master die retaining board has a working surface, a master depth, a plurality of die rule slots formed in the working surface, and a die rule insert-receiving recess. The die rule insert-receiving recess has an opening at the working surface and extends into the master die retaining board in a depth direction. The die rule insert-receiving recess has an inner peripheral sidewall and a plurality of interlock bays. Each interlock bay has an opening at the working surface and a vertical opening intersecting with the inner peripheral sidewall. The die rule insert has a shape that is complementary to the shape of the die rule insert-receiving recess. The die rule insert has an insert working surface, a depth, a configuration of one or more die rule slots formed in the insert working surface, and an outer periphery. Along the outer periphery, interlock features are provided extending from the outer periphery. The interlock features have shapes that enable the interlock features to be received in and interlock with the interlock bays formed in the master die retaining board.

To form a composite die retaining board, the die rule insert is inserted into the die rule insert-receiving recess. The insert working surface can be flush with the working surface of the master die retaining board. A plurality of die rules can be installed in the plurality of die rule slots formed in the working surface of the master die retaining board. One or more insert die rules can be installed in one or more of the die rule slots formed in the insert working surface. The working surface of the master die retaining board can lie on a plane. A plurality of die rules installed in the plurality of die rule slots formed in the working surface of the master die retaining board can distal working edges that extend a distance away from the plane. One or more die rules installed in the die rule slots formed in the insert working surface can have one or more distal edges that extend the same distance away from the plane. The die rule insert and the master die retaining board can have the same or different depths.

At least one of the plurality of die rules can be installed in the die rule slots in the working surface of the master die retaining board. One or more of the installed die rules can be an inter-board die rule. One or more inter-board die rules can traverse at least one of the interlock features. The plurality of interlock features can comprise a plurality of dovetails. The dovetails can comprise a plurality of four-corner-rounded dovetails. The dovetails can comprise a plurality of six-corner-rounded, stemmed dovetails. In some embodiments, the interlock features can be provided in the master die retaining board and the interlock bays can be provided in the die rule insert.

The die rule insert-receiving recess can have a depth that is equal to the master depth and can pass through the master die retaining board. for example, to form a hole through the master die retaining board. The die rule insert-receiving recess can have a depth that is less than the master depth and the die rule insert-receiving recess can have a bottom surface that is made of the master die retaining board, for example, so that the die rule insert-receiving recess neither passes through nor forms a hole in the master die retaining board.

Systems are also provided by the present invention, and can include an ejection bolt. The die rule insert can comprise a plurality of threaded through-holes each having an inner thread, and the ejection bolt can comprise an outer thread that is complementary to the inner threads. One or more, for example, at least two, of the threaded through-holes can be formed adjacent at least two of the plurality of interlock features. A threaded through-hole for an ejection bolt can be formed adjacent each respective interlock feature.

According to various embodiments of the present invention, a system is provided that comprises a composite die retaining board as described herein, a first die rule insert as described herein, and at least one other, for example, a second, die rule insert. The second die rule insert can also have a shape that is complementary to the shape of the die rule insert-receiving recess. The second die rule insert can have a second insert working surface, a second depth, a second configuration of one or more die rule slots formed in the second insert working surface, a second outer periphery, and a second plurality of interlock features. The second plurality of interlock features can extend from the second outer periphery and can have shapes that enable the second interlock features to be received in and interlock with the interlock bays. The second configuration of one or more die rule slots can be different than the configuration of one or more die rule slots formed in the die rule insert.

According to various embodiments of the present invention, a method of changing a die rule insert of a composite die is also provided. The method can comprise providing a system have two or more die rule inserts as described herein, installing a first die rule insert into the die rule insert-receiving recess to form a first composite die retaining board, and ejecting the first die rule insert from the die rule insert-receiving recess. The method can further involve installing a second die rule insert into the die rule insert-receiving recess to form a second, different, composite die retaining board. Each die rule insert can comprise a plurality of threaded through-holes each having an inner thread, and the ejecting can comprise threading an ejection bolt into one or more of the threaded through-holes so that a distal end of the ejection bolt extends through the one or more threaded through-holes and forces the die rule insert to be pushed away from the die rule insert-receiving recess.

The method can further comprise installing one or more inter-board die rules into a first composite die rule retaining board, and then removing the one or more inter-board die rules from the first composite die rule retaining board before ejecting the die rule insert. Further, the method can comprise installing a second die rule insert, after ejecting the first die rule insert, to form a second composite die rule retaining board. Then, one or more inter-board die rules can be installed into the second composite die rule retaining board. At least one of the one or more inter-board die rules installed into the first composite die rule retaining board can be installed in a die rule slot formed in the master die retaining board and can traverse at least one of the interlock features.

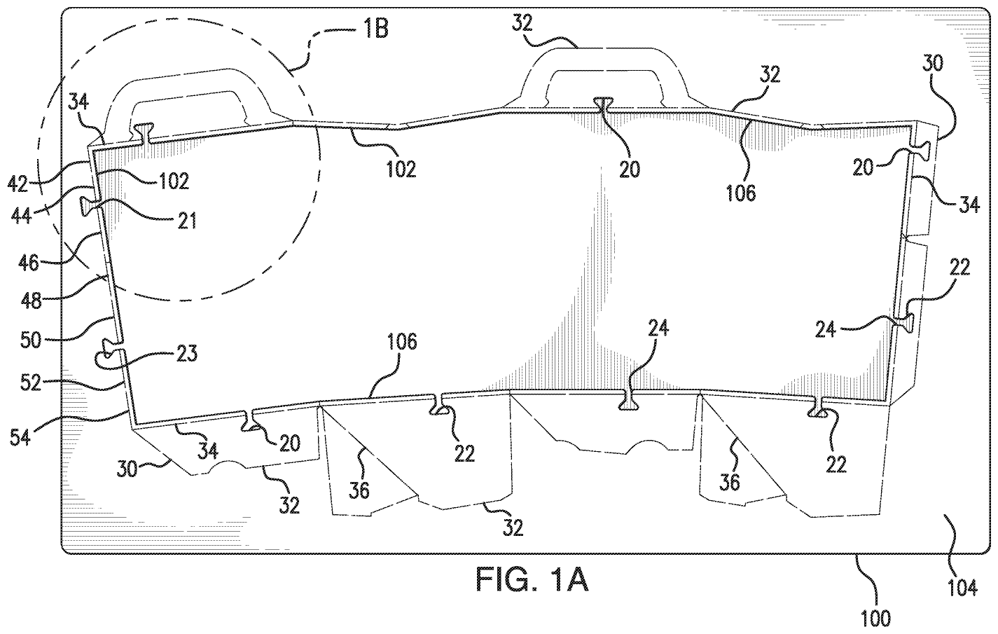

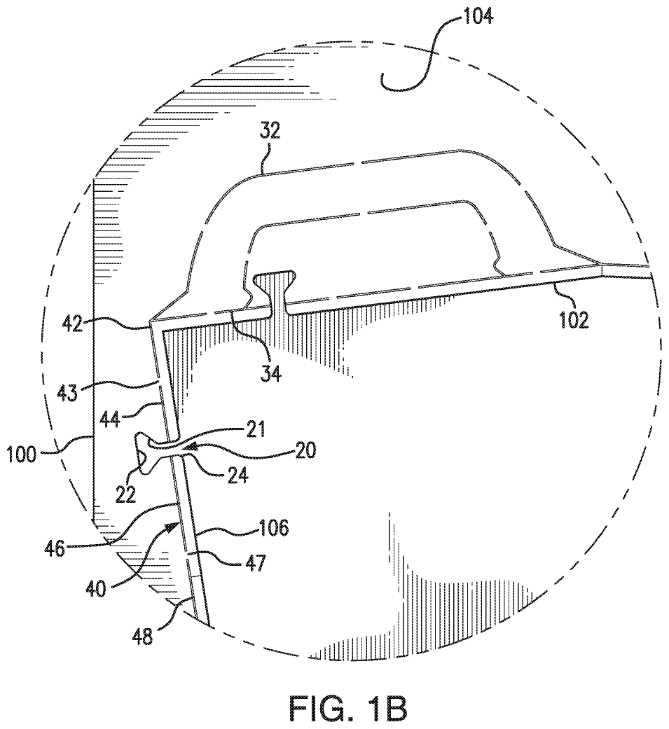

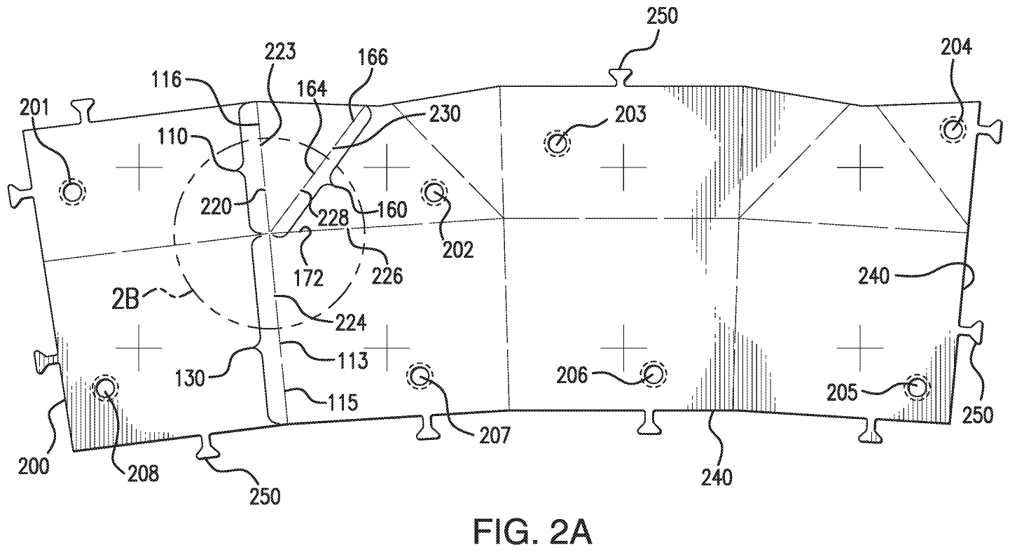

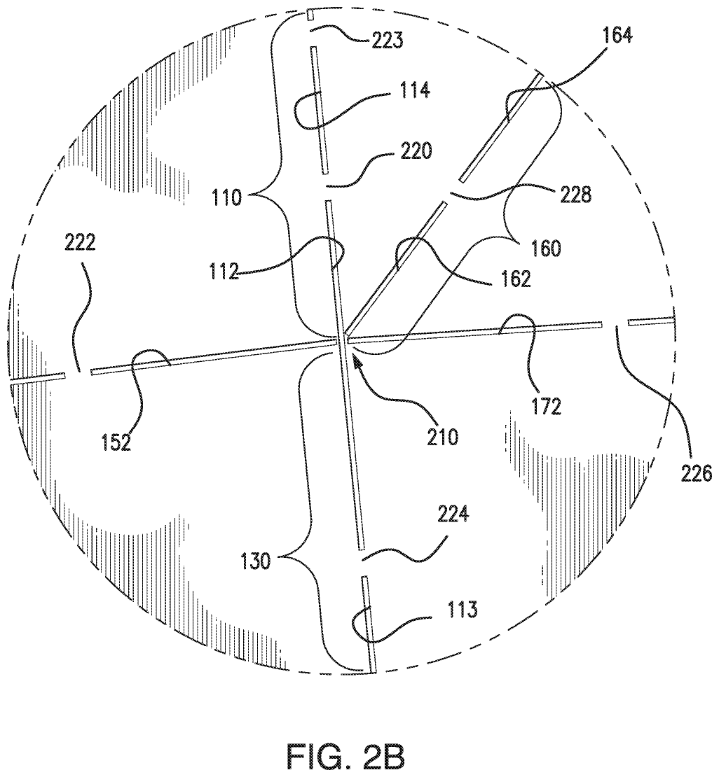

With reference now to the drawings, FIGS. 1A and 1B show a master die retaining board 100 having a die rule insert-receiving recess 102, a top surface 104, and a plurality of die rule slots as described below. Although depicted as single lines, each of the die rule slots shown has a width and defines a gap between two opposing sidewalls. A close-up of exemplary die rule slots is shown in FIG. 2B, including segmented die rule slots as described below. Recess 102 has an inner periphery, roughly rectangular in shape, a sidewall 106, and a plurality of interlock bays 20 each having a top opening 22, at top surface 104, and a vertical opening 24 along sidewall 106. Each vertical opening 24 has a depth that can be, but is not necessarily, equal to a depth of recess 102. Top openings 22, along with a cross-section of each interlock bay 20, can diverge in a direction away from sidewall 106. Each interlock bay vertical opening 24 intersects with sidewall 106.

A plurality of die rule slots 30 are formed in top surface 104 and can extend part way into or fully through master die retaining board 100. When formed by laser cutting, die rule slots 30 can extend all the way though master die retaining board 100. Die rule slots 30 can be in the form of die slots 32 for holding cutting dies, die slots 34 for holding creasing dies, and die slots 36 for holding perforating dies. One of more die slots can also or instead be provided for holding one or more scoring die rules, one or more embossing die rules, or the like. FIGS. 1A and 1B do not show any die rules in any of the die rule slots.

As can be seen in FIGS. 1A and 1B, a left-side segmented die rule slot 40 for cutting the left edge of a workpiece can be formed of a plurality of subslots 42, 44, 46, 48, 50, 52, and 54. The subslots are separated and spaced apart from one another by, among other features, bridges 43, 47, 49, and 53 where no cut has been made in master die retaining board 100. Subslots 44 and 46 are separated and spaced apart from one another by interlock bay 21. Subslots 50 and 52 are separated and spaced apart from one another by interlock bay 23.

As can further be seen in FIGS. 1A and 1B, upon forming a composite die retaining board by inserting a die rule insert into recess 102, a single, uninterrupted cutting die rule can be installed in slot 40 and can include an uninterrupted cutting edge and a plurality of recesses or cut-outs formed from the bottom up. An exemplary die rule insert is shown in FIGS. 2A and 2B. As can be seen from GIGS. 1A and 1B, the recesses enable the cutting die rule to straddle bridges 43, 47, 49, and 53 and to straddle interlock features, for example, dovetails that have been inserted into and are complementary to interlock bays 21 and 23. Such recesses in die rules are known, for example, from U.S. Pat. No. 5,197,367, which is incorporated herein in its entirety by reference. While a continuous uninterrupted die rule can be used in segmented die slot 40 (FIG. 1B), a plurality of shorter die rules can instead be used having ends that butt up against each other to form a cutting feature along the entirety of segmented die rule slot 40.

FIGS. 2A and 2B are top plan views of a die rule insert 200 that can fit into die rule insert-receiving recess 100 shown in FIGS. 1A and 1B. Once die rule insert 200 is inserted into recess 100, a composite die retaining board is formed. No die rules are installed in any of the die rule slots shown in FIGS. 2A and 2B. Die rule insert 200 has an outer periphery 240 from which extend a plurality of interlock features 250. Interlock features 250 shown in FIG. 2A are in the form of six-corner-rounded, stemmed dovetails. The arrangement, sizes, and shapes of interlock features 250 are such that they align with and fit into the interlock bays 20 shown in FIGS. 1A and 1B, and only in one certain orientation.

In the enlarged view of FIG. 2B, the portion of FIG. 2A shown at section 2B is illustrated in detail. FIG. 2B shows a die rule slot intersection 210 where a continuous die rule slot 112 passes through and provides uninterrupted die rule slot portions on opposite sides of intersection 210. Also intersecting at intersection 210 are die rule subslots 152, 162, and 172. FIG. 2B also shows segmented die rule slots including segmented die rule slot 110, segmented die rule slot 130, and segmented die rule slot 160. Each of the die rule subslots 152 and 172 are a part of a longer segmented die rule slot.

Segmented die rule slot 110 comprises the portion of die rule subslot 112 that begins at intersection 210 and ends at a bridge 220. Segmented die rule slot 110 also includes the entireties of die rule subslot 114 and die rule subslot 116 (FIG. 2A) separated by bridge 223. Segmented die rule slot 130 includes the portion of die rule subslot 112 that begins at intersection 210 and ends at a bridge 224, along with the entirety of die rule subslot 113 and the entirety of die rule subslot 115 shown in FIG. 2A. As can be seen, subslots 112 and 113 are separated by bridge 224. As can also be seen, subslots 114 and 116 are separated by a bridge 223. Segmented die rule slot 160 comprises die rule subslots 162, 164, and 166 that are divided by bridges 228 and 230.

Each of segmented die rule slots 110, 130, and 160, as well as all other die rule subslots and segmented die rule slots shown in FIGS. 2A and 2B are configured to hold creasing, scoring, or perforating die rules. Die rule inserts with die rule slots for holding cutting die rules can also, or instead, be included.

As can also be seen in FIGS. 2A and 2B, segmented die rule slot 130 is a continuation of segmented die rule slot 110 and is parallel with segmented die rule slot 110. Die rule subslots 152 and 172 are not parallel to one another. Die rules, when inserted into subslots 152 and 172, terminate, and each butts up against a die rule occupying subslots 112, at intersection 210.

Generally, die rules are installed into the die slots of the die rule insert after the die rule insert is inserted into the master die, die rule insert-receiving recess. According to various embodiments, however, die rules can be installed in the die rule insert before the die rule insert is inserted into the recess.

Once the die rule insert (FIGS. 2A and 2B) is inserted into the master die insert-receiving recess (FIGS. 1A and 1B), a composite die retaining board is formed. Once die rules are installed in the composite die retaining board, a composite die is formed. Depending upon the desired shape to be cut with the composite die, the composite die retaining board can be formed with a plurality of die rules slots for holding appropriate die rules. One or more of the die rule slots of the composite retaining board can be a continuous slot extending from the die rule insert to the master die. In other words, some slots for a die can be formed partly in the die rule insert and partly in the master die. Herein, such a slot is referred to as an inter-board die rule slot and is configured to hold an inter-board die rule.

In the case of inter-board die rule slots, the die rules are inserted into the die slots after the die rule insert is fitted into the master die insert-receiving recess. When exchanging or swapping-out for a new die rule insert, inter-board die rules are removed from the inter-board die rule slots before the die rule insert is ejected from the master die insert-receiving recess. Once a new die rule insert is fitted into the master die insert-receiving recess, the inter-board die rules or new die rules or inter-board die rules can then be inserted into the inter-board die rule slots.

The master die and the die rule insert can each comprise a retaining board made of wood, plastic, or other suitable material provided with a plurality of die slots. Each retaining board can comprise a RAYFORM material, available from Essential Products of Bedford Park, Ill. RAYFORM is a family of die board materials, including, for example RAYFORM DURAPLY, RAYFORM POLYCORE, RAYFORM DURACORE, and KLEAN KERF die materials. As an example, an 11/16-inch RAYFORM die board can be used for each of the master die and the die rule insert. The die slots may be formed by any conventional apparatus such as a laser beam or a jig saw. Steel rule dies can be used that have a width that is slightly less than the width of the die slots. Accordingly, a steel rule die may be inserted into an associated die slot. The master die, the die rule insert, or both, can comprise a non-metallic material, for example, a resin, a polymer, a plastic, a wood, a RAYFORM dieboard material available from Wagner Die Supply (Elmhurst Ill.), a laminate material, combinations thereof, or the like.

The master die can have a triangular shape, a square shape, a rounded shape, a polygonal shape, a rectangular shape, or any other shape. The master die can comprise a retaining board having a rectangular shape, wherein two sides of the retaining board can be parallel to each other. The master die can have a first thickness and the die rule insert can have a second thickness. The second thickness can be the same as the first thickness or can be less than the first thickness. For example, the second thickness can be 10% less, 30% less, 50% less, 60% less, 70% less, 80% less, or 90% less than the first thickness.

To prevent the inserted die from loosening within the die slot, an urging means can be provided within lock slots adjacent to the die slots, in a predetermined fashion. Lock slots can be in communication with die slots via an open face. As will be apparent to one skilled in the art from the present application, the number and locations of the urging means and associated lock slots are determined by considering such factors as optimum securing of the inserted dies, configuration of the die rule, and manufacturing costs. Each urging means can comprise, for example, a KERF LOCK or a NEVERDIE DIE device, both of which are available from Atlas Die, LLC, of Rochester Hills, Michigan.

The die slots are not continuous as a continuous slot would weaken the retaining board and a die rule could fall through the die slot. Discontinuities in the die slots are in the form of bridges. Each die rule has one or more recesses that enable the rule to bridge the corresponding retaining board or boards between cut die slots, at the bridges.

A KERF LOCK can be used and is preferably of a unitary construction that can be easily injection molded. A KERF LOCK comprises two arms connected by a bridge at one end and separated by a gap at the other end. A KERF LOCK is generally n-shaped.

When a KERF LOCK is disposed within a lock slot of a retaining board, one arm rests against the retaining board while the other arm has a force transmitting surface that extends into the die slot. When a die rule is inserted into the die slot, the force transmitting arm, or resilient arm, is forced in a direction toward the resting or support arm. This creates a spring-type force such that the force transmitting surface of the force transmitting arm exerts a pressure against the die rule, which secures the die rule in the die slot. Although a sufficient pressure is applied to hold the die rule in the die slot, the rule may be pulled out of the die slot, for example, with a pair of pliers. In most cases, no disassembly of the composite retaining board, the die lock, or the die rule insert is necessary to pull out any of the die rules, even inter-board die rules. The number of KERF LOCKS can be varied to supply greater or lesser pressure to hold the die rule in the die slot. Other urging means can be used, for example, magnetic urging means, spring-loaded urging means, and the like.

As seen in FIG. 2, threaded holes 201, 202, 203, 204, 205, 206, 207, and 208 are formed in and through die rule insert 200. The threaded holes can be tapped into die rule insert 200, drilled into die rule insert 200, or provided by accommodating a threaded insert, for example, a dual-threaded key-locking threaded insert. Exemplary of such threaded inserts is the KEYSERT® insert available form Recoil Quality Thread Insert Systems of Bangalore, India. To further exemplify such inserts, an 8 mm insert length can be used, an M8×1.25 external thread size can be used, an M4×0.70 internal thread size can be used, or the like. Stainless steel inserts, for example, with a passivated finish, a Grade 303, or both, can be used. The threaded inserts can be configured and/or arranged around the periphery of the die rule insert, spaced apart from one another, so that the ejection bolts, also referred to as jack bolts, can be threaded therethrough and apply equally distributed pressure around the periphery of the die rule insert to facilitate removing the die rule insert from the master die insert-receiving recess. The ejection bolt threaded receiving holes, can be positioned adjacent one, two, three, four, more than four, or each, dovetail of the die rule insert.

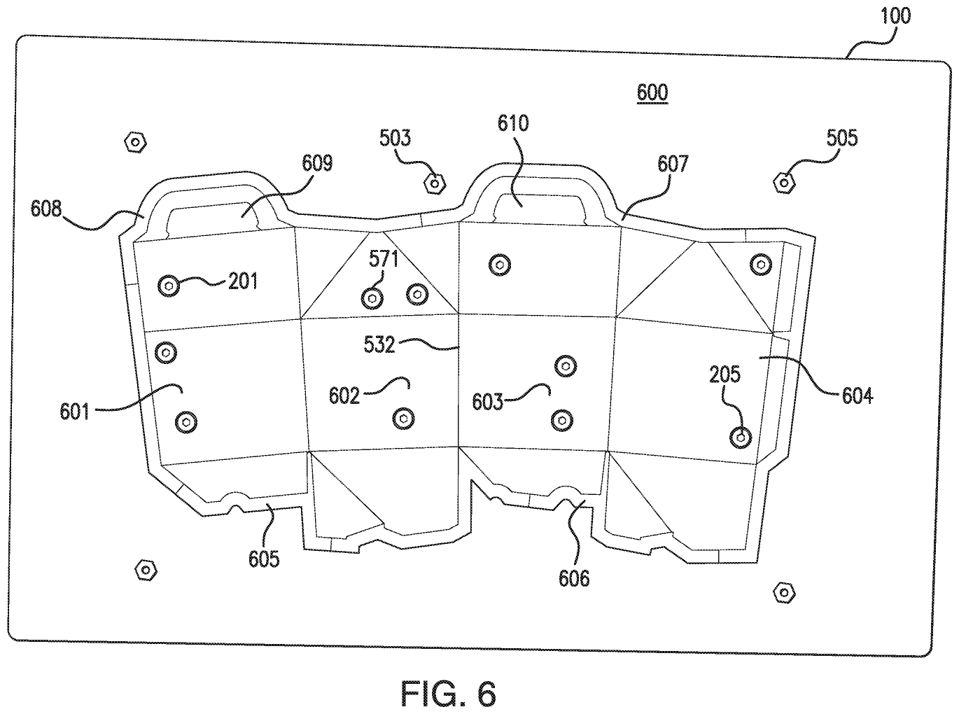

Such threaded inserts can also be provided through or in the backside of master die 100, through or in the backside of die rule insert 200, or in both, so that the master die, the die rule insert, or both, can be bolted to a chase or platen of a die cutting press. For bolting the die rule insert to a chase, two such threaded inserts, 571 and 572, can be used in the die rule insert as illustrated in FIG. 5. The threaded holes for mounting the die rule insert to a chase can be larger than, or the same size as, the threaded through-holes included in the die rule insert for ejection bolts.

Threaded inserts are particularly useful for mounting the master die to a chase or platen. The threaded inserts can be arranged so that two or more of them lines-up with and can receive anchoring bolts for mounting master die 100 on a die cutter, a die cutter chase, a die cutter platen, or the like. Dual-threaded key-locking threaded inserts can be used that are configured and sized to receive mounting bolts to fasten the master die onto a die cutter chase, such as a Bobst chase available from Bobst Group North America Inc., of Little Switzerland, North Carolina. Exemplary mounting bolts that can be used include M4×12 metric flat head cap screws, or the like.

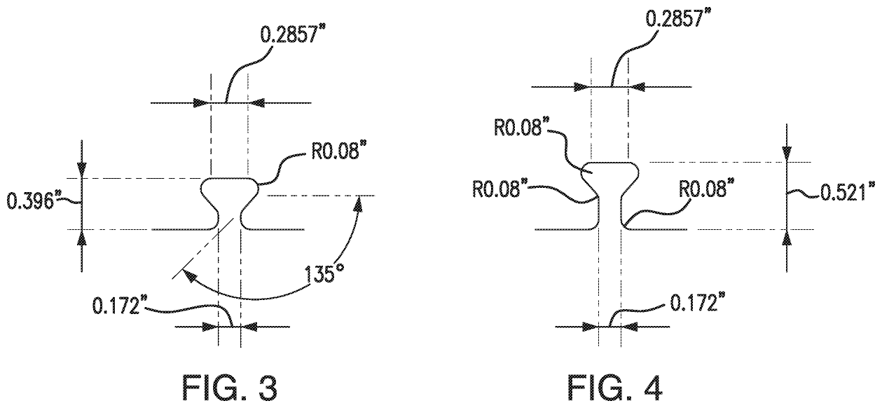

FIG. 3 is an enlarged view of an exemplary four-corner-rounded dovetail interlock feature according to various embodiments of the present invention. The dovetail shown in FIG. 3 is exemplary only and is not intended to limit the scope of the present invention. The rounded corners facilitate insertion and removal of a die rule insert comprising such interlock features. The rounded corners and dovetail shape also help to minimize or avoid delamination of one or more laminated layers if such laminated layers are used for the die rule insert, the master die retaining board, or both.

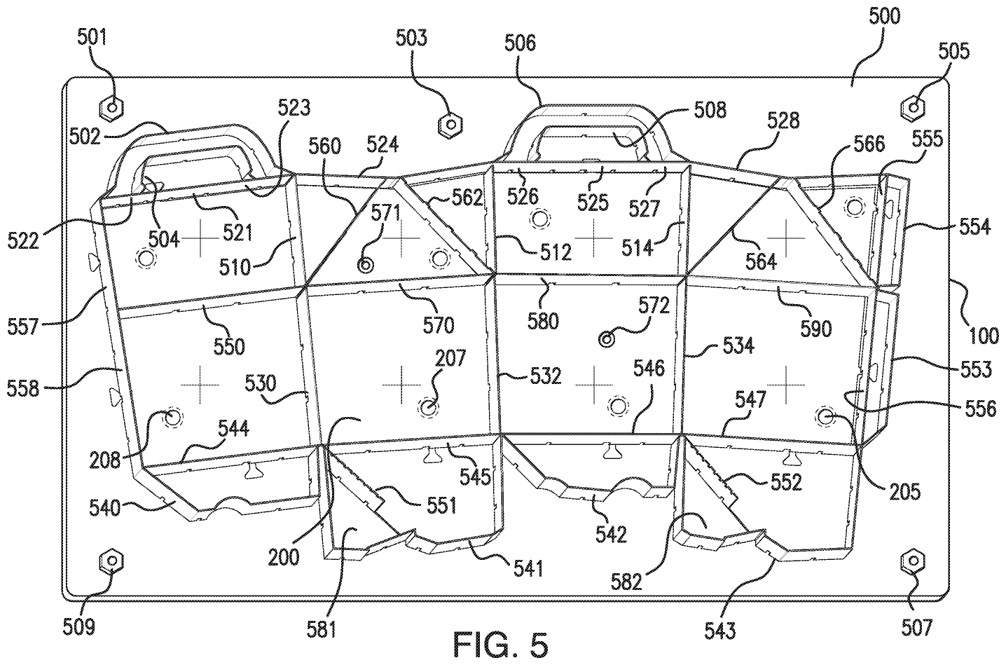

FIG. 4 is an enlarged view of an exemplary six-corner-rounded, stemmed dovetail interlock feature according to various embodiments of the present invention. The dovetail shown in FIG. 4 is exemplary only and is not intended to limit the scope of the present invention. The rounded corners facilitate insertion and removal of a die rule insert comprising such interlock features. The rounded corners and dovetail shape also help to minimize or avoid delamination of one or more laminated layers if such laminated layers are used for the die rule insert, the master die retaining board, or both. The stem portion of each interlock feature provides a minimal bridge span for a die rule recess of an inter-board die rule, to span. As can be seen, the six-corner-rounded, stemmed dovetail interlock feature is the configuration used in the embodiment shown in FIGS. 1A, 1B, and 2A.

FIG. 5 is a top plan view of a die 500 for die-cutting a box. Die 500 includes master die 100 shown in FIGS. 1A and 1B and die rule insert 200 shown in FIGS. 2A and 2B. As can be seen in FIG. 5, die rule insert 200 has been inserted into master die insert-receiving recess 102 of master die 100 and die rules have been inserted in all the die rule slots. Die rules 502, 504, 506, 508, 521, 524, 525, 528, 540, 541, 542, 543, 553, 554, 557, and 558 are all cutting rules and together cut out the outline of a workpiece that can be folded and glued to form a box having four side panels, a bottom, a top, and two handles. Die rules 522, 523, 526, 527, 530, 532, 534, 544, 545, 546, 547, 550, 555, 556, 560, 570, 580, 590, 562, 564, and 566, are all creasing rules, during a die-cutting operation, form creases and fold lines on the workpiece. Die rules 551 and 552 are perforating rules for forming perforations in box bottom panels 581 and 582, respectively. Many of the die rules, for example, die rules 544,545, 546, 547, 555, 556, 566, and others, are inter-board die rules in that they extend across a portion of the surface of master die 100 and across a portion of the surface of die rule insert 200. To remove and replace die rule insert 200, the inter-board die rules can first be removed to provide access to die rule insert 200.

FIG. 5 also shows five different registration pin bushing assemblies 501, 503, 505, 507, and 509 mounted to master die 100. As can be seen, the registration pin bushing assemblies are spread out across the surface of master die 100 with registration pin bushing assemblies 501, 505, 507, and 509 generally located in the four respective corners of master die 100. A respective hex nut countersunk into the opposite surface of master die 100 can be configured to engage and hold the respective hex bushing to master die 100.

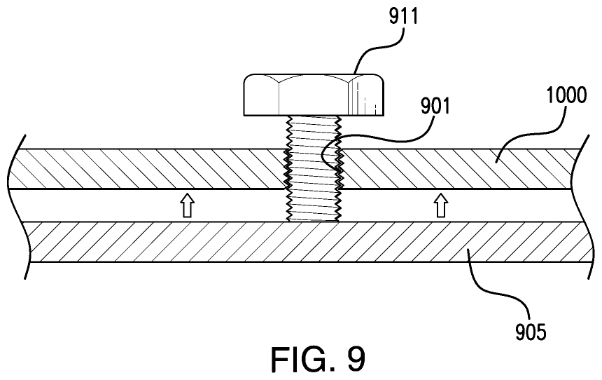

Each hex bushing can include a smooth through-bore formed through the center of a stem of the hex bushing. The smooth through-bores are each configured to snuggly receive a roll pin or split pin, and the pins can be used to receive holes in a counterplate to facilitate aligning the counterplate with the master die and combination die. Each smooth through-bore can have a slightly smaller inner diameter relative to the outer diameter of the roll pin. For example, the through-bores can have an inner diameter of 250/1000 of an inch whereas the outer diameter of each roll pin can be 257/1000. As such, the roll pin must compress slightly to fit within the through-bore and the resulting engagement is firm but releasable. Similarly, corresponding through-holes or recesses in a counterplate, for example, as shown in FIG. 8, can each have a slightly smaller inner diameter relative to the outer diameter of the roll pins. For example, through-holes in a counterplate can have inner diameters of 250/1000 of an inch each whereas the outer diameter of each roll pin can be 257/1000. As such, each roll pin must compress slightly to fit within a respective through-hole of the counterplate, and the resulting engagement is firm but releasable. Such a registration system can be useful for a one-time registration of an adhesive-backed counterplate with the master die and the composite die as the counterplate is adhered to a counter-chase in a die-cutting press.

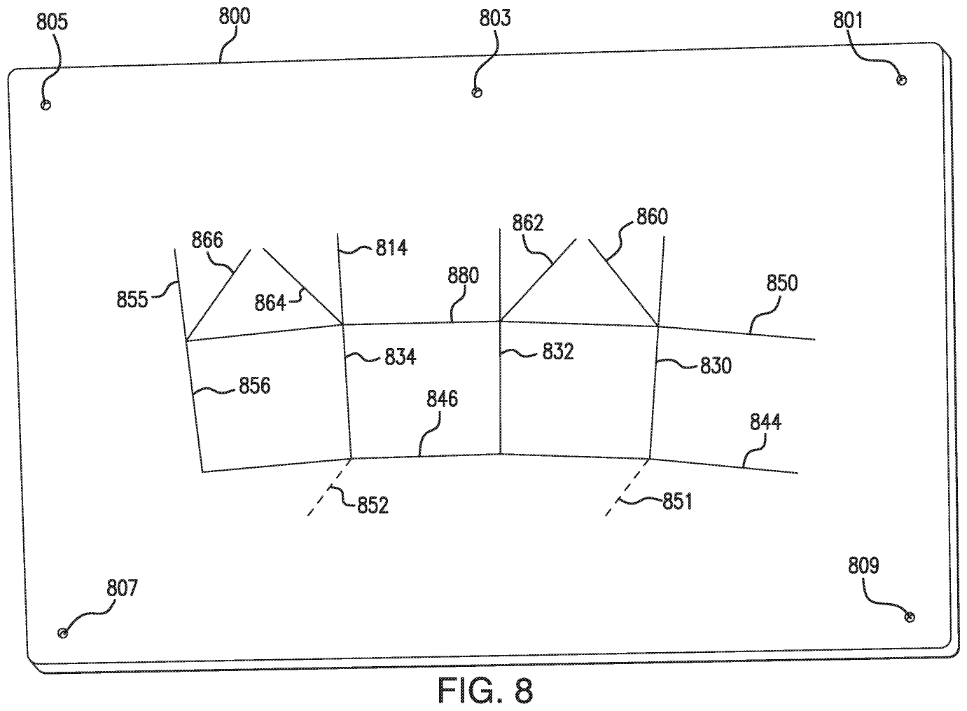

Each roll pin can be held by friction in a respective one of the counterplate through-holes for a one-time alignment process. The back of the counterplate can be spray-coated with adhesive, or adhesive can otherwise be applied thereto, and the holding force of the adhesive can be greater than the force holding the roll pins in the through-holes of the counterplate. Upon a first pressing in a die cutter, the counterplate can thus be adhered to a chase or platen of the die cutter while remaining aligned with the metallic, flat die magnetically held on the flat mounting area. More details of counterplate registration are described below and shown in FIGS. 7 and 8.

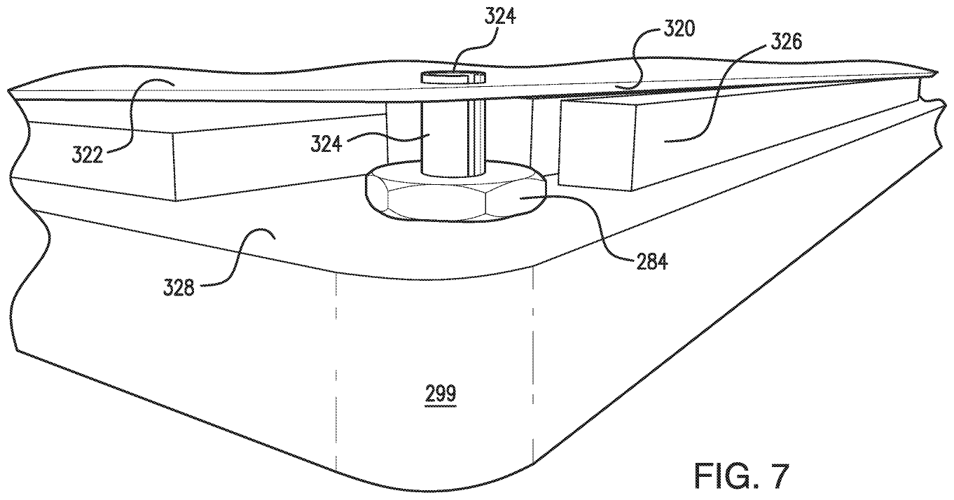

FIG. 6 is a top plan view of a completed die 600 including die 500 shown in FIG. 5, but further showing elastically deformable ejection material fixed around the die rules. The ejection material, for example, shown at 601, 602, 603, 604, 605, 606, 607, 608, and 609, has been glued-in around, outside, and inside the various die rules. The ejection material is elastically deformable and compresses under the force of a die cutting press cutting a paperboard to form a box blank. After being compressed, and after the cutting force is removed, i.e., the die cutting press is opened, the ejection material then rebounds and pushes or ejects the cut paperboard away from the die rules so that neither the cut paperboard blank nor any surrounding scrap paperboard material hangs-up on the die rules.

FIG. 7 is a close-up side view of a corner of an assembly 299 according to an exemplary embodiment of the present invention. FIG. 7 shows a counterplate 320 aligned with assembly 299. Counterplate 320 includes a bonding surface 322 onto which an adhesive is applied. Upon an initial pressing in a die cutter, the adhesive will bond bonding surface 322 of counterplate 320 onto a chase or platen of the die cutter. Assembly 299 is in the form of a composite die according to an embodiment of the present invention. Due to the composite die being bolted to an opposing chase or platen of the same die cutter, the composite die and counterplate will initially be aligned with one another and remain that way through many pressings of the die cutter. A roll pin 324, or split pin, can be seen held in a smooth through-bore of a hex bushing 284. Roll pin 324 can be seen extending from assembly 299 up to and through a through-hole in counterplate 320. By using four or five of such arrangements of bushings, roll pins, and counterplate through holes, counterplate 320 can be precisely aligned with assembly 299, in the die cutter. A strip of ejection material 326 is also seen in FIG. 7.

As seen in FIG. 8, a counterplate 800 that can be used with, and according to, embodiments of the present invention includes a plurality of counterplate registration through-holes, for example, five through-holes 801, 803, 805, 807, and 809. The through-holes are provided for receiving split pins or roll pins. Such roll pins can be positioned, for example, in the hex bushings shown in the completed composite die shown in FIG. 6. According to such an arrangement, roll pins in hex bushings 501, 503, 505, 507, and 509 of the completed composite die shown in FIG. 6, align with and are received in through-holes 801, 803, 805, 807, and 809, respectively, of counterplate 800. Other die cutting patterns and corresponding counterplates are within the scope of the present teachings.

The through-holes shown in FIG. 8 can be configured to align with and receive roll pins that are held in five hex bushings of the cooperating completed composite die. The counterplate registration through-holes can be used to align with any of the composite dies described herein. With such an alignment system, counterplate 800 can thereby be aligned with the master die and die rule insert as described herein. According to various embodiments of the present invention, aligned assemblies and methods of making and using the same are also provided.

FIG. 8 is a configuration of receiving grooves that forms a mirror image of the die pattern provided by the completed composite die of FIG. 6, but without the mirror-image pattern of the cutting die rules. FIG. 8 shows a plurality of grooves for receiving only the creasing and perforating die rules of the completed composite die, that is, in this case, for receiving the inside die rules of the completed composite die shown in FIG. 6. No grooves, however, are provided for receiving the cutting die rules, in this case, the outer die rules of the completed composite die shown in FIG. 6. The outer die rules of the die of FIG. 6 are cutting dies and so no corresponding grooves to receive them are provided in counterplate 800. The outside cutting dies are configured and dimensioned to strike against the counterplate. In the exemplary embodiment shown, only grooves for the inside die rules of the cutting pattern are countersunk into the counterplate. The receiving grooves are very thin and shallow.

As can be seen in FIG. 8, a plurality of counterplate die receiving grooves are provided that can be configured to receive creasing die rules, perforating die rules, or both. In particular, counterplate 800 includes perforating receiving grooves 851, 852, 860, 862, 864, and 866 configured to receive and form a perforation with perforating dies 551, 552, 560, 562, 564 and 566, respectively, that are shown in FIGS. 5 and 6. Counterplate 800 includes a plurality of creasing receiving grooves, including, as examples, grooves 814, 830, 832, 834, 844, 846, 850, 855, 856, and 880 configured to receive and form creases with creasing dies 514, 530, 532, 534, 544, 546, 550, 555, 556, and 580, respectively, shown in FIGS. 5 and 6.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such a range is separately disclosed. Where a range of numerical values is recited herein, unless otherwise stated, the range is intended to include the endpoints thereof, and all integers and fractions within the range. It is not intended that the scope of the invention be limited to the specific values recited when defining a range.

All patents, patent applications, and publications mentioned herein are incorporated herein in their entireties, by reference, unless indicated otherwise.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A composite die retaining board for use in forming a composite die, the composite die retaining board comprising:
a master die retaining board having a working surface, a master depth, a plurality of die rule slots formed in the working surface, and a die rule insert-receiving recess, the die rule insert-receiving recess having an opening at the working surface and extending into the master die retaining board in a depth direction, the die rule insert-receiving recess having an inner peripheral sidewall and a plurality of interlock bays, each interlock bay having an opening at the working surface and a vertical opening intersecting with the inner peripheral sidewall; and
a die rule insert having a shape that is complementary to the shape of the die rule insert-receiving recess, the die rule insert having an insert working surface, a depth, a configuration of one or more die rule slots formed in the insert working surface, an outer periphery, and a plurality of interlock features extending from the outer periphery and having shapes that enable the interlock features to be received in and interlock with the interlock bays, wherein
at least a portion of the plurality of die rule slots formed in the working surface of the master die retaining board form a cutting footprint, and the die rule insert-receiving recess is within the cutting footprint.

2. The composite die retaining board of claim 1, wherein the die rule insert is inserted into the die rule insert-receiving recess.

3. The composite die retaining board of claim 2, wherein the insert working surface is flush with the working surface of the master die retaining board.

4. The composite die retaining board of claim 2, further comprising a plurality of die rules installed in the plurality of die rule slots formed in the working surface of the master die retaining board.

5. The composite die retaining board of claim 4, further comprising one or more insert die rules installed in the one or more die rule slots formed in the insert working surface.

6. The composite die retaining board of claim 5, wherein the working surface of the master die retaining board lies on a plane, the plurality of die rules installed in the plurality of die rule slots formed in the working surface of the master die retaining board have first distal working edges, the one or more die rules installed in the one or more die rule slots formed in the insert working surface have one or more second distal edges, and the first and second distal edges extend the same distance away from the plane.

7. The composite die retaining board of claim 4, wherein at least one of the plurality of die rules installed in the plurality of die rule slots formed in the working surface of the master die retaining board is an inter-board die rule that traverses at least one of the interlock features.

8. The composite die retaining board of claim 1, wherein the die rule insert-receiving recess has a depth that is equal to the master depth and passes through the master die retaining board.

9. The composite die retaining board of claim 1, wherein the die rule insert-receiving recess has a depth that is less than the master depth and the die rule insert-receiving recess has a bottom surface made of the master die retaining board.

10. (canceled)

11. The composite die retaining board of claim 1, wherein the plurality of interlock features comprises a plurality of four-corner-rounded dovetails.

12. The composite die retaining board of claim 1, wherein the plurality of interlock features comprises a plurality of six-corner-rounded stemmed dovetails.

13. The composite die retaining board of claim 1, further comprising an ejection bolt, wherein the die rule insert comprises a plurality of threaded through-holes each having an inner thread, and the ejection bolt comprises an outer thread that is complementary to the inner threads.

14. The composite die retaining board of claim 13, wherein at least two of the threaded through-holes are formed adjacent at least two of the plurality of interlock features.

15. A system comprising the composite die retaining board of claim 1, and a second die rule insert, the second die rule insert having a shape that is complementary to the shape of the die rule insert-receiving recess, the second die rule insert having a second insert working surface, a second depth, a second configuration of one or more die rule slots formed in the second insert working surface, a second outer periphery, and a second plurality of interlock features extending from the second outer periphery and having shapes that enable the second interlock features to be received in and interlock with the interlock bays, wherein the second configuration of one or more die rule slots is different than the configuration of one or more die rule slots formed in the die rule insert.

16. A method of changing a die rule insert of a composite die, the method comprising:
providing the system of claim 15;
installing the die rule insert into the die rule insert-receiving recess to form a first composite die retaining board;
ejecting the die rule insert from the die rule insert-receiving recess; and
installing the second die rule insert into the die rule insert-receiving recess to form a second, different, composite die retaining board.

17. The method of claim 16, wherein the die rule insert comprises a plurality of threaded through-holes each having an inner thread, and the ejecting comprises threading an ejection bolt into one or more of the threaded through-holes so that a distal end of the ejection bolt extends through the one or more threaded through-holes and forces the die rule insert to be pushed away from the die rule insert-receiving recess.

18. The method of claim 16, further comprising:
installing one or more inter-board die rules into the first composite die rule retaining board;
removing the one or more inter-board die rules from the first composite die rule retaining board, before ejecting the die rule insert; and
installing one or more inter-board die rules into the second composite die rule retaining board.

19. The method of claim 18, wherein at least one of the one or more inter-board die rules installed into the first composite die rule retaining board is installed in a die rule slot formed in the master die retaining board and traverses at least one of the interlock features.

20. The composite die retaining board of claim 1, wherein the die rule insert-receiving recess is completely within the cutting footprint.

21. A composite die retaining board for use in forming a composite die, the composite die retaining board comprising:
a master die retaining board having a working surface, a master depth, a plurality of die rule slots formed in the working surface, and a die rule insert-receiving recess, the die rule insert-receiving recess having an opening at the working surface and extending into the master die retaining board in a depth direction, the die rule insert-receiving recess having an inner peripheral sidewall and a plurality of interlock bays, each interlock bay having an opening at the working surface and a vertical opening intersecting with the inner peripheral sidewall; and
a die rule insert having a shape that is complementary to the shape of the die rule insert-receiving recess, the die rule insert having an insert working surface, a depth, a configuration of one or more die rule slots formed in the insert working surface, an outer periphery, and a plurality of interlock features extending from and defined by the outer periphery and having shapes that enable the interlock features to be received in and interlock with the interlock bays, wherein the plurality of interlock features comprises a plurality of dovetails having rounded corners.
